(19) United States
(12) Patent Application Publication
(10) Pub. No.: US 2024/0214887 A1
(43) Pub. Date: Jun. 27, 2024

(54) METHOD AND APPARATUS FOR INTRA FREQUENCY CELL RESELECTION CONSIDERING RADIO CAPABILITY IN A WIRELESS COMMUNICATION SYSTEM

(71) Applicant: LG ELECTRONICS INC., Seoul (KR)

(72) Inventors: Hyunjung CHOE, Seoul (KR); Sunghoon JUNG, Seoul (KR)

(73) Assignee: LG ELECTRONICS INC., Seoul (KR)

(21) Appl. No.: 18/555,809

(22) PCT Filed: May 9, 2022
(86) PCT No.: PCT/KR2022/006544

§ 371 Date: Oct. 17, 2023

(30) Foreign Application Priority Data
May 10, 2021 (KR) 10-2021-0060167

(51) Int. Cl. H04W 36/00; H04W 48/02

(52) U.S. Cl. CPC H04W 36/008355; H04W 48/02

(57) ABSTRACT

A method and apparatus for intra-frequency cell reselection considering radio capability in a wireless communication system is provided. A wireless device may receive, from a cell, barring information informing that the cell is barred. A wireless device may receive, from the cell, a radio capability-specific intra-frequency cell reselection indicator (IFRI) related to a number of Rx branches and/or reception power. A wireless device may determine whether to perform intra-frequency cell reselection, based on the radio capability-specific IFRI.

### CROSS-REFERENCE TO RELATED APPLICATIONS

This application is the National Stage filing under 35 U.S.C. 371 of International Application No. PCT/KR2022/006544, filed on May 9, 2022, which claims the benefit of earlier filing date and right of priority to Korean Application No. 10-2021-0060167, filed on May 10, 2021, the contents of which are all hereby incorporated by reference herein in their entireties.

### TECHNICAL FIELD

The present disclosure relates to a method and apparatus for intra-frequency cell reselection considering radio capability in a wireless communication system.

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

Thanks to the wide service coverage capabilities and reduced vulnerability of space/airborne vehicles to physical attacks and natural disasters, non-terrestrial networks (NTN) are expected to:
foster the roll out of 5G service in un-served areas that cannot be covered by terrestrial 5G network (isolated/remote areas, on board aircrafts or vessels) and underserved areas (e.g., sub-urban/rural areas) to upgrade the performance of limited terrestrial networks in cost effective manner,
reinforce the 5G service reliability by providing service continuity for machine-to-machine (M2M)/Internet-of-things (IOT) devices or for passengers on board moving platforms (e.g., passenger vehicles-aircraft, ships, high speed trains, bus) or ensuring service availability anywhere especially for critical communications, future railway/maritime/aeronautical communications, and to
enable 5G network scalability by providing efficient multicast/broadcast resources for data delivery towards the network edges or even user terminal.

### SUMMARY

If a UE uses a less number of Rx branches than other UEs around, the base station may use high-powered transmissions to the UE to compensate poor reception conditions. If the UE detects reception power strength becomes stronger, the UE may also set stronger transmitting power because it assumes that a stronger power level is required for communications between the UE and the base station. For example, the UE using the 1Rx branch may use higher power strength to communicate with the base station than that of the UE using the 4Rx branches.

For non-terrestrial networks (NTN), reception power could be different depending on the types of satellites or the types of cells (for example, GEO type, LEO type, between GEO/LEO types, earth fixed cells, earth moving cells). In addition, the power strength to communicate with NTN and TN could be different from each other. Communication power in NTN would require more transmitting power than that in TN. Thus, UEs may use differentiated power strength depending on the types of networks (that is NTN, TN), satellites, or cells.

Strong communication power may increase the probability of interferences with other UEs using the same frequency. Especially, if the number of UEs deployed in the area is many such as Industrial Wireless Sensor Network (IWSN) scenarios. The legacy intra-cell reselection indication specified by a cell, however, does not consider different communication power strength among UEs.

As UE radio capabilities such as the number of antenna branches or differentiated reception power affect communication power between the UE and the base station, it is beneficial to consider UE radio capabilities to decide whether the cell or the cells on the same frequency as a candidate for intra-frequency cell reselection.

If a cell allows intra-frequency cell reselection for all UEs without considering different UE radio capabilities, the UEs using stronger communication power than others will cause interferences, and eventually, all UEs in the area will suffer from interferences.

Therefore, studies for intra-frequency cell reselection considering radio capability in a wireless communication system are required.

In an aspect, a method performed by a wireless device in a wireless communication system is provided. A wireless device may receive, from a cell, barring information informing that the cell is barred. A wireless device may receive, from the cell, a radio capability-specific intra-frequency cell reselection indicator (IFRI) related to a number of Rx branches and/or reception power. A wireless device may determine whether to perform intra-frequency cell reselection, based on the radio capability-specific IFRI.

In another aspect, an apparatus for implementing the above method is provided.

The present disclosure can have various advantageous effects.

According to some embodiments of the present disclosure, a wireless device could perform intra-frequency cell reselection efficiently by considering radio capability.

For example, the UE could determine candidate cells for intra-frequency cell (re)selection based on the network indicator considering radio capabilities such as the number of antennas and reception power of UEs. Therefore, it is possible for the base station to efficiently control the network interferences.

In other words, by applying radio capability-specific IFRI, it is possible to determine whether each UE performs intra-frequency cell reselection based on the UE's capability. In addition, by considering communication power, it is possible to reduce communication failure due to interference.

For example, efficient network management could be possible. Since more sophisticated interference control is possible by introducing an intra-frequency cell reselection tolerance factor in consideration of the communication power of the UE. In terms of the UE, it is possible to reduce communication failure due to interference.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 shows another example of wireless devices to which implementations of the present disclosure is applied.

FIG. 5 shows an example of UE to which implementations of the present disclosure is applied.

FIGS. 6 and 7 show an example of protocol stacks in a 3GPP based wireless communication system to which implementations of the present disclosure is applied.

FIG. 8 shows a frame structure in a 3GPP based wireless communication system to which implementations of the present disclosure is applied.

FIG. 9 shows a data flow example in the 3GPP NR system to which implementations of the present disclosure is applied.

FIG. 10 shows an example of a method for intra-frequency cell reselection considering radio capability in a wireless communication system, according to some embodiments of the present disclosure.

FIG. 11 shows an example of operations for radio capability-specific intra-frequency cell reselection.

FIG. 12 shows an example of UE operations for radio capability-specific intra-frequency cell reselection.

FIG. 13 shows an embodiment of operations of a base station for radio capability-specific intra-frequency cell reselection.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE.

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

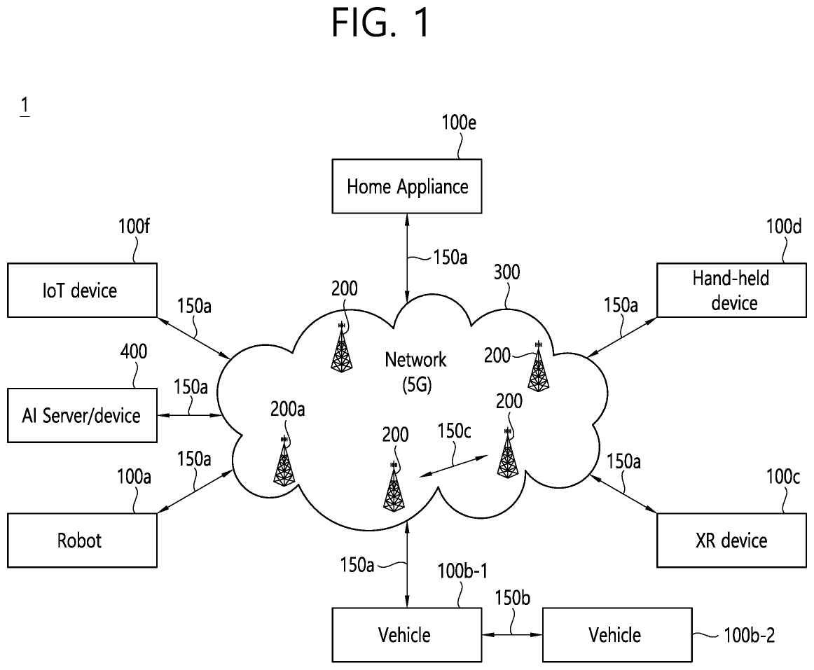

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IOT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

Here, the radio communication technologies implemented in the wireless devices in the present disclosure may include narrowband internet-of-things (NB-IOT) technology for low-power communication as well as LTE, NR and 6G. For example, NB-IOT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

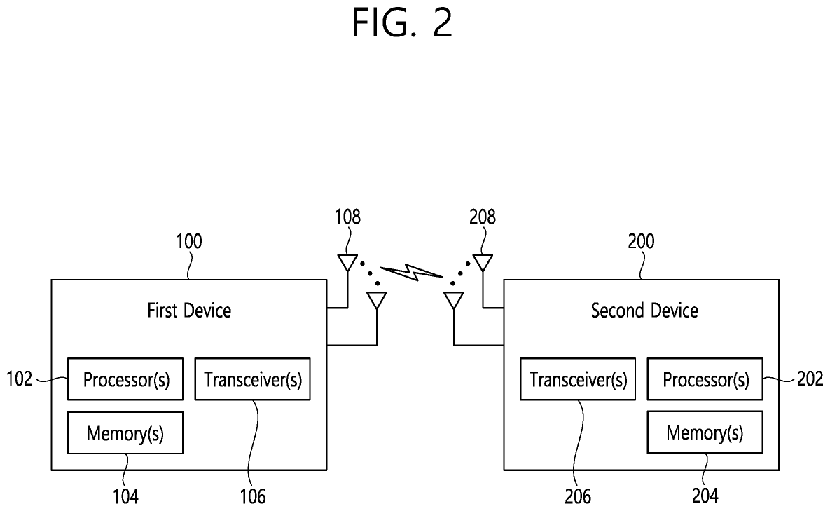

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR). In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, suggestions, methods and/or operational flowcharts described in the present disclosure. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory (s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, suggestions, methods and/or operational flowcharts described in the present disclosure. Herein, the processor(s) 102 and the memory (s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with radio frequency (RF) unit(s). In the present disclosure, the first wireless device 100 may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, suggestions, methods and/or operational flowcharts described in the present disclosure. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory (s) 204. The memory(s) 204 may be connected to the processor(s) 202 and may store a variety of information related to operations of the processor(s) 202. For example, the memory (s) 204 may store software code including commands for performing a part or the entirety of processes controlled by the processor(s) 202 or for performing the descriptions, functions, procedures, suggestions, methods and/or operational flowcharts described in the present disclosure. Herein, the processor(s) 202 and the memory (s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas may be a plurality of physical antennas or a plurality of logical antennas (e.g., antenna ports).

The one or more transceivers 106 and 206 may convert received radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the transceivers 106 and 206 can up-convert OFDM baseband signals to a carrier frequency by their (analog) oscillators and/or filters under the control of the processors 102 and 202 and transmit the up-converted OFDM signals at the carrier frequency. The transceivers 106 and 206 may receive OFDM signals at a carrier frequency and down-convert the OFDM signals into OFDM baseband signals by their (analog) oscillators and/or filters under the control of the transceivers 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

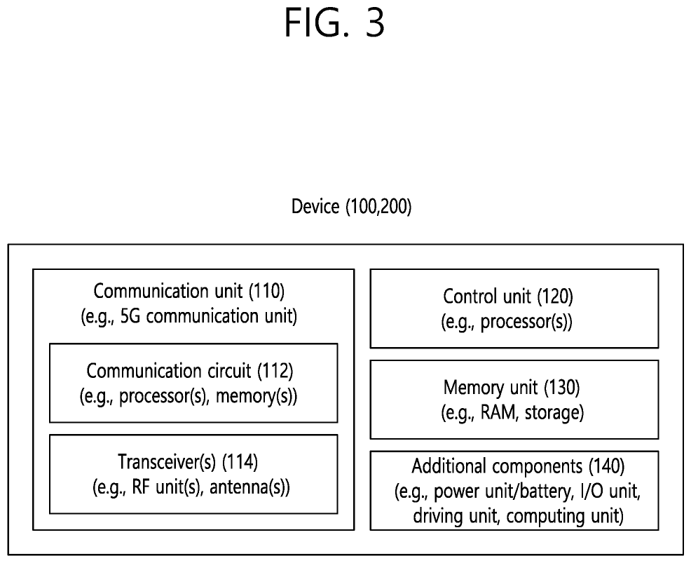

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory 130, and the additional components 140) and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory 130 may be configured by a RAM, a DRAM, a ROM, a flash memory, a volatile memory, a non-volatile memory, and/or a combination thereof.

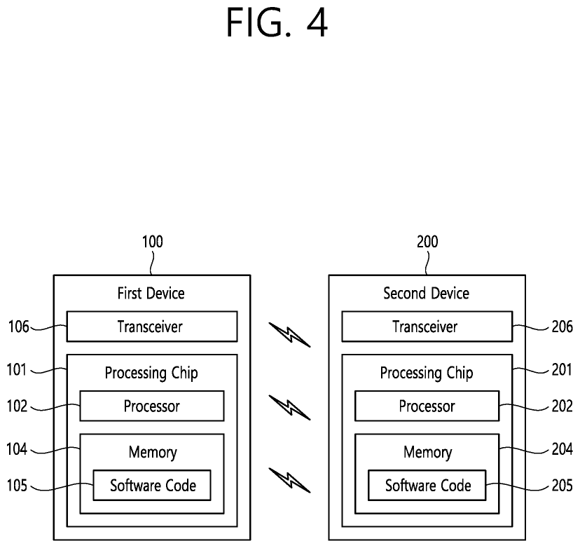

FIG. 4 shows another example of wireless devices to which implementations of the present disclosure is applied.

Referring to FIG. 4, wireless devices 100 and 200 may correspond to the wireless devices 100 and 200 of FIG. 2 and may be configured by various elements, components, units/portions, and/or modules.

The first wireless device 100 may include at least one transceiver, such as a transceiver 106, and at least one processing chip, such as a processing chip 101. The processing chip 101 may include at least one processor, such a processor 102, and at least one memory, such as a memory 104. The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 may perform one or more layers of the radio interface protocol.

The second wireless device 200 may include at least one transceiver, such as a transceiver 206, and at least one processing chip, such as a processing chip 201. The processing chip 201 may include at least one processor, such a processor 202, and at least one memory, such as a memory 204. The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 may perform one or more layers of the radio interface protocol.

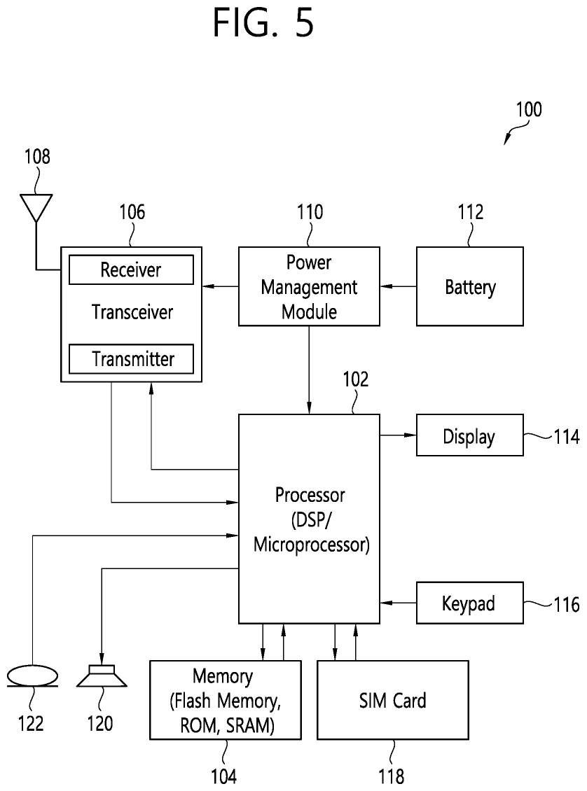

FIG. 5 shows an example of UE to which implementations of the present disclosure is applied.

Referring to FIG. 5, a UE 100 may correspond to the first wireless device 100 of FIG. 2 and/or the first wireless device 100 of FIG. 4.

A UE 100 includes a processor 102, a memory 104, a transceiver 106, one or more antennas 108, a power management module 110, a battery 1112, a display 114, a keypad 116, a subscriber identification module (SIM) card 118, a speaker 120, and a microphone 122.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of a digital signal processor (DSP), a central processing unit (CPU), a graphics processing unit (GPU), a modem (modulator and demodulator). An example of the processor 102 may be found in SNAPDRAGON™ series of processors made by Qualcomm®, EXYNOS™series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 110 manages power for the processor 102 and/or the transceiver 106. The battery 112 supplies power to the power management module 110.

The display 114 outputs results processed by the processor 102. The keypad 116 receives inputs to be used by the processor 102. The keypad 16 may be shown on the display 114.

The SIM card 118 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The speaker 120 outputs sound-related results processed by the processor 102. The microphone 122 receives sound-related inputs to be used by the processor 102.

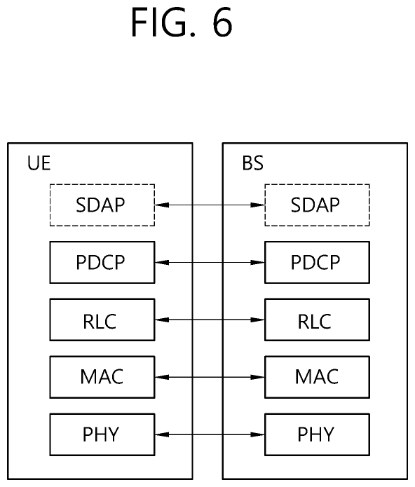

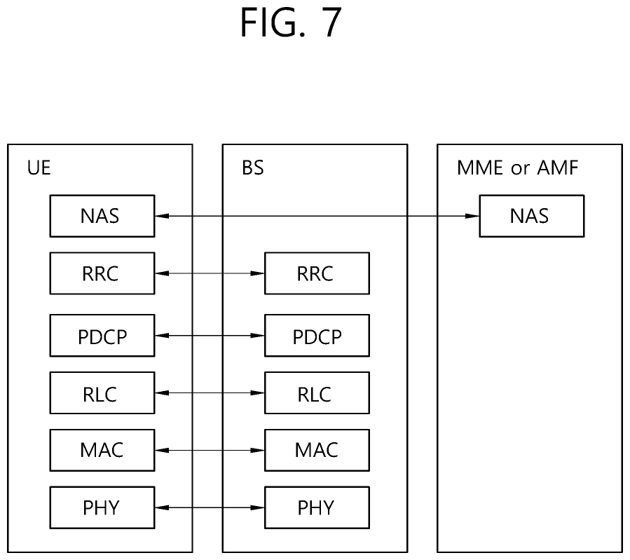

FIGS. 6 and 7 show an example of protocol stacks in a 3GPP based wireless communication system to which implementations of the present disclosure is applied.

In particular, FIG. 6 illustrates an example of a radio interface user plane protocol stack between a UE and a BS and FIG. 7 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 6, the user plane protocol stack may be divided into Layer 1 (i.e., a PHY layer) and Layer 2. Referring to FIG. 7, the control plane protocol stack may be divided into Layer 1 (i.e., a PHY layer). Layer 2. Layer 3 (e.g., an RRC layer), and a non-access stratum (NAS) layer. Layer 1. Layer 2 and Layer 3 are referred to as an access stratum (AS).

In the 3GPP LTE system, the Layer 2 is split into the following sublayers: MAC. RLC, and PDCP. In the 3GPP NR system, the Layer 2 is split into the following sublayers: MAC. RLC. PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QOS) flows.

In the 3GPP NR system, the main services and functions of the MAC sublayer include: mapping between logical channels and transport channels: multiplexing/de-multiplexing of MAC SDUs belonging to one or different logical channels into/from transport blocks (TB) delivered to/from the physical layer on transport channels: scheduling information reporting: error correction through hybrid automatic repeat request (HARQ) (one HARQ entity per cell in case of carrier aggregation (CA)): priority handling between UEs by means of dynamic scheduling: priority handling between logical channels of one UE by means of logical channel prioritization: padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate

different kinds of data transfer services, multiple types of logical channels are defined. i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH): BCCH can be mapped to downlink shared channel (DL-SCH): PCCH can be mapped to paging channel (PCH): CCCH can be mapped to DL-SCH: DCCH can be mapped to DL-SCH: and DTCH can be mapped to DL-SCH. In uplink, the following connections between logical channels and transport channels exist: CCCH can be mapped to uplink shared channel (UL-SCH): DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs: sequence numbering independent of the one in PDCP (UM and AM): error correction through ARQ (AM only); segmentation (AM and UM) and re-segmentation (AM only) of RLC SDUs: reassembly of SDU (AM and UM): duplicate detection (AM only); RLC SDU discard (AM and UM): RLC re-establishment: protocol error detection (AM only).

In the 3GPP NR system, the main services and functions of the PDCP sublayer for the user plane include: sequence numbering: header compression and decompression using robust header compression (ROHC): transfer of user data: reordering and duplicate detection: in-order delivery: PDCP PDU routing (in case of split bearers): retransmission of PDCP SDUs; ciphering, deciphering and integrity protection: PDCP SDU discard: PDCP re-establishment and data recovery for RLC AM: PDCP status reporting for RLC AM: duplication of PDCP PDUs and duplicate discard indication to lower layers. The main services and functions of the PDCP sublayer for the control plane include: sequence numbering: ciphering, deciphering and integrity protection: transfer of control plane data: reordering and duplicate detection: in-order delivery: duplication of PDCP PDUs and duplicate discard indication to lower layers.

In the 3GPP NR system, the main services and functions of SDAP include: mapping between a QoS flow and a data radio bearer: marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS: paging initiated by 5 GC or NG-RAN: establishment, maintenance and release of an RRC connection between the UE and NG-RAN; security functions including key management: establishment, configuration, maintenance and release of signaling radio bearers (SRBs) and data radio bearers (DRBs): mobility functions (including: handover and context transfer, UE cell selection and reselection and control of cell selection and reselection, inter-RAT mobility): QoS management functions: UE measurement reporting and control of the reporting: detection of and recovery from radio link failure: NAS message transfer to/from NAS from/to UE.

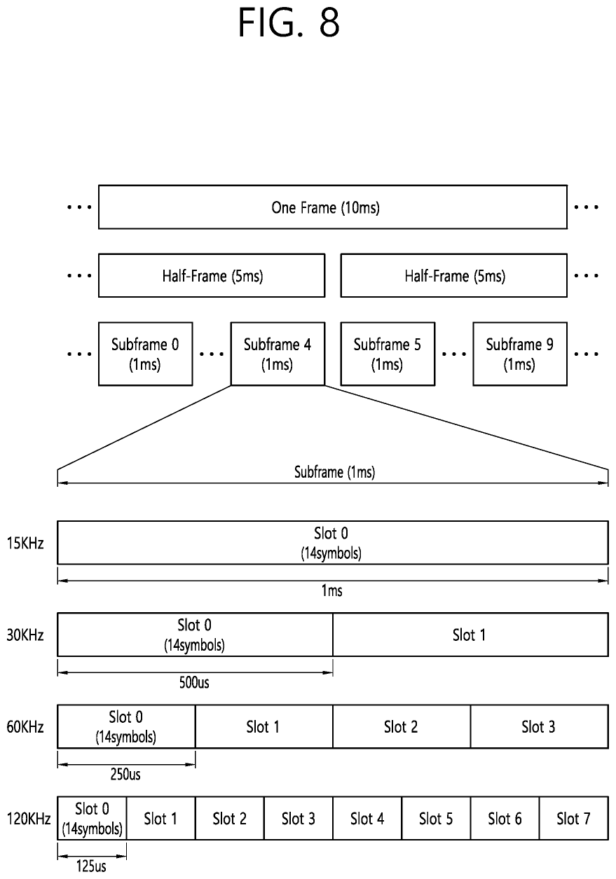

FIG. 8 shows a frame structure in a 3GPP based wireless communication system to which implementations of the present disclosure is applied.

The frame structure shown in FIG. 8 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 8, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing Δf=2^{u*}15 KHz.

Table 1 shows the number of OFDM symbols per slot N^{slot}_{symb}, the number of slots per frame N^{frame.u}ₛₗₒₜ, and the number of slots per subframe N^{subframe,u}ₛₗₒₜ for the normal CP, according to the subcarrier spacing Δf=2^{u*}15 KHz.

TABLE 1

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 2 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing Δf=2^{u*}15 KHz.

TABLE 2

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid.x}*/N^{RB}_{SC} subcarriers and N^{subframe,u}_{symb} OFDM symbols is defined, starting at common resource block (CRB)N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{Size.u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index/representing a symbol location relative to a reference point in the time domain. In the 3GPP based wireless communication system, an RB is defined by 12 consecutive subcarriers in the frequency domain.

In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i-1}, where i is the number of the bandwidth part. The relation between the physical resource block n_{PRB} in the bandwidth part i and the common resource block n_{CRB} is as follows: n_{PRB}=N_{CRB}+N^{SIZE}_{BWP,i}, Where N^{Size}_{BWP} i is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

The NR frequency band may be defined as two types of frequency range, i.e., FR1 and FR2. The numerical value of the frequency range may be changed. For example, the frequency ranges of the two types (FR1 and FR2) may be as shown in Table 3 below. For ease of explanation, in the frequency ranges used in the NR system, FR1 may mean “sub 6 GHz range”, FR2 may mean “above 6 GHz range,” and may be referred to as millimeter wave (mmW).

TABLE 3

| Frequency Range | Corresponding | |
|---|---|---|
| designation | frequency range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 4 below. That is, FR1 may include a frequency band of 6 GHz (or 5850, 5900, 5925 MHz, etc.) or more. For example, a frequency band of 6 GHZ (or 5850, 5900, 5925 MHz, etc.) or more included in FR1 may include an unlicensed band. Unlicensed bands may be used for a variety of purposes, for example for communication for vehicles (e.g., autonomous driving).

TABLE 4

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells. for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

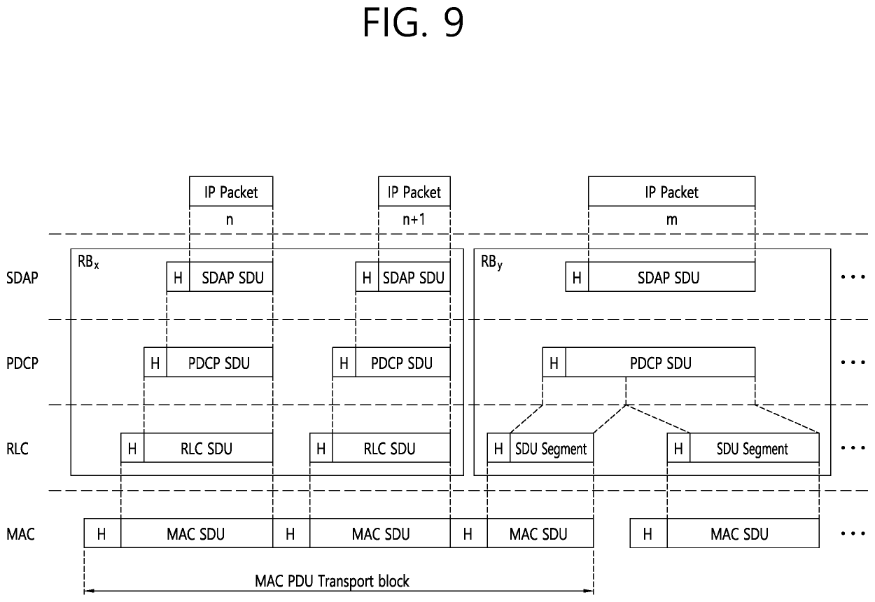

FIG. 9 shows a data flow example in the 3GPP NR system to which implementations of the present disclosure is applied.

Referring to FIG. 9, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels PUSCH and PRACH, respectively, and the downlink transport channels DL-SCH, BCH and PCH are mapped to PDSCH, PBCH and PDSCH, respectively. In the PHY layer, uplink control information (UCI) is mapped to PUCCH, and downlink control information (DCI) is mapped to PDCCH. A MAC PDU related to UL-SCH is transmitted by a UE via a PUSCH based on an UL grant, and a MAC PDU related to DL-SCH is transmitted by a BS via a PDSCH based on a DL assignment.

Hereinafter, technical features related to cell reselection are described. Section

9.2.1.2 of 3GPP TS 38.300 v16.5.0 may be referred.

A UE in RRC_IDLE performs cell reselection. The principles of the procedure are the following:
Cell reselection is always based on CD-SSBs located on the synchronization raster.
The UE makes measurements of attributes of the serving and neighbour cells to enable the reselection process:
For the search and measurement of inter-frequency neighbouring cells, only the carrier frequencies need to be indicated.
Cell reselection identifies the cell that the UE should camp on. It is based on cell reselection criteria which involves measurements of the serving and neighbour cells:
Intra-frequency reselection is based on ranking of cells;
Inter-frequency reselection is based on absolute priorities where a UE tries to camp on the highest priority frequency available;
An NCL can be provided by the serving cell to handle specific cases for intra- and inter-frequency neighbouring cells;
Black lists can be provided to prevent the UE from reselecting to specific intra- and inter-frequency neighbouring cells;
White lists can be provided to request the UE to reselect to only specific intra- and inter-frequency neighbouring cells;
Cell reselection can be speed dependent;
Service specific prioritisation.

In multi-beam operations, the cell quality is derived amongst the beams corresponding to the same cell.

Hereinafter, technical features related to cell reselection are described. Parts of section 5.2.2.4.1, section 5.2.2.4.2, and section 5.2.2.5 of 3GPP TS 38.331 v16.3.1 may be referred.

### Actions Upon Reception of the MIB

Upon receiving the MIB the UE shall:
1> store the acquired MIB;
1> if the UE is in RRC_IDLE or in RRC_INACTIVE, or if the UE is in RRC_CONNECTED while T311 is running:
2> if the cellBarred in the acquired MIB is set to barred:
3>consider the cell as barred:
3> if intraFreqReselection is set to notAllowed; and
3> if the cell operates in licensed spectrum or the cell belongs to a PLMN which is indicated as being equivalent to the registered PLMN or the cell belongs to the registered SNPN of the UE:
4>consider cell re-selection to other cells on the same frequency as the barred cell as not allowed.
3> else:
4>consider cell re-selection to other cells on the same frequency as the barred cell as allowed, as specified in TS 38.304 [20].
2> else:
3> apply the received systemFrameNumber, pdcch-ConfigSIB1, subCarrierSpacingCommon, ssb-SubcarrierOffset and dmrs-TypeA-Position.

### Actions Upon Reception of the SIB1

Upon receiving the SIB1 the UE shall:
1> store the acquired SIB1:
1> if the cellAccessRelatedInfo contains an entry of a selected SNPN or PLMN and in case of PLMN the UE is either allowed or instructed to access the PLMN via a cell for which at least one CAG ID is broadcast:
2> in the remainder of the procedures use npn-IdentityList, trackingAreaCode. and cellIdentity for the cell as received in the corresponding entry of npn-IdentityInfoList containing the selected PLMN or SNPN;
1> else if the cellAccessRelatedInfo contains an entry with the PLMN-Identity of the selected PLMN;
2> in the remainder of the procedures use plmn-IdentityList, trackingAreaCode, and cellIdentity for the cell as received in the corresponding PLMN-IdentityInfo containing the selected PLMN;
1> if in RRC_CONNECTED while T311 is not running:
2>disregard the frequencyBandList, if received, while in RRC_CONNECTED;
2>forward the cellIdentity to upper layers;
2>forward the trackingAreaCode to upper layers;
2>forward the received posSIB-MappingInfo to upper layers, if included;
2> apply the configuration included in the servingCellConfigCommon;
2> if the UE has a stored valid version of a SIB or posSIB, that the UE requires to operate within the cell:
3>use the stored version of the required SIB or posSIB;
2> else:
3>acquire the required SIB or posSIB requested by upper layer;
1> else:
2> if the UE supports one or more of the frequency bands indicated in the frequencyBandList for downlink for TDD, or one or more of the frequency bands indicated in the frequencyBandList for uplink for FDD, and they are not downlink only bands, and
2> if the UE is IAB-MT or supports at least one additionalSpectrumEmission in the NR-NS-PmaxList for a supported band in the downlink for TDD, or a supported band in uplink for FDD, and
2> if the UE supports an uplink channel bandwidth with a maximum transmission bandwidth configuration which
is smaller than or equal to the carrier Bandwidth (indicated in uplinkConfigCommon for the SCS of the initial uplink BWP), and which
is wider than or equal to the bandwidth of the initial uplink BWP, and
2> if the UE supports a downlink channel bandwidth with a maximum transmission bandwidth configuration which
is smaller than or equal to the carrier Bandwidth (indicated in downlinkConfigCommon for the SCS of the initial downlink BWP), and which
is wider than or equal to the bandwidth of the initial downlink BWP, and
2> if frequencyShift7p5khz is present and the UE supports corresponding 7.5 kHz frequency shift on this band: or frequencyShift7p5khz is not present:
3> if trackingAreaCode is not provided for the selected PLMN nor the registered PLMN nor PLMN of the equivalent PLMN list:
4>consider the cell as barred;
4> if intraFreqReselection is set to notAllowed:
5>consider cell re-selection to other cells on the same frequency as the barred cell as not allowed;
4> else:
5>consider cell re-selection to other cells on the same frequency as the barred cell as allowed;
3> else:
4> apply a supported uplink channel bandwidth with a maximum transmission bandwidth which
is contained within the carrierBandwidth indicated in uplinkConfigCommon for the SCS of the initial uplink BWP, and which
is wider than or equal to the bandwidth of the initial BWP for the uplink;
4> apply a supported downlink channel bandwidth with a maximum transmission bandwidth which
is contained within the carrier Bandwidth indicated in downlinkConfigCommon for the SCS of the initial downlink BWP, and which
is wider than or equal to the bandwidth of the initial BWP for the downlink;
4>select the first frequency band in the frequencyBandList, for FDD from frequencyBandList for uplink, or for TDD from frequencyBandList for downlink, which the UE supports and for which the UE supports at least one of the additionalSpectrumEmission values in nr-NS-PmaxList, if present;
4>forward the cellIdentity to upper layers;
4>forward the trackingAreaCode to upper layers;
4>forward the received posSIB-MappingInfo to upper layers, if included;
4>forward the PLMN identity or SNPN identity or PNI-NPN identity to upper layers;
4> if in RRC_INACTIVE and the forwarded information does not trigger message transmission by upper layers:
5> if the serving cell does not belong to the configured ran-NotificationAreaInfo:
6> initiate an RNA update;
4>forward the ims-EmergencySupport to upper layers, if present;
4>forward the eCallOverIMS-Support to upper layers, if present;
4>forward the UAC-AccessCategoryl-SelectionAssistanceInfo or UAC-ACI-SelectAssistInfo for the selected PLMN to upper layers, if present and set to a, b or c;
4> apply the configuration included in the servingCellConfigCommon;
4> apply the specified PCCH configuration;
( . . . )
2> else:
3>consider the cell as barred; and
3> perform barring as if intraFreqReselection is set to notAllowed;

### Essential System Information Missing

The UE shall:
1> if in RRC_IDLE or in RRC_INACTIVE or in RRC_CONNECTED while T311 is running:
2> if the UE is unable to acquire the MIB:
3>consider the cell as barred; and
3> perform barring as if intraFreqReselection is set to allowed;
2> else if the UE is unable to acquire the SIB1;
3>consider the cell as barred.
3> if the cell operates in licensed spectrum and intraFreqReselection in MIB is set to notAllowed:
4>consider cell re-selection to other cells on the same frequency as the barred cell as not allowed.
3> else:
4>consider cell re-selection to other cells on the same frequency as the barred cell as allowed.

Hereinafter, an example of MIB is described.

MIB includes the system information transmitted on BCH.

Signalling radio bearer: N/A

RLC-SAP: TM

Logical channel: BCCH

Direction: Network to UE

Table 5 shows an example of MIB.

TABLE 5
-- ASN1START
-- TAG-MIB-START

| | |
|---|---|
| MIB ::= | SEQUENCE { |
| systemFrameNumber | BIT STRING (SIZE (6)), |
| subCarrierSpacingCommon | ENUMERATED {scs15or60, |
| | scs30or120}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, |
| | notBarred}, |
| intraFreqReselection | ENUMERATED {allowed, |
| | notAllowed}, |
| spare | BIT STRING (SIZE (1)) |

}
-- TAG-MIB-STOP
-- ASN1STOP

The intraFreqReselection in table 5 may be used to control cell selection/reselection to intra-frequency cells when the highest ranked cell is barred, or treated as barred by the UE. This field is ignored by IAB-MT.

Hereinafter, technical features related to cell status and cell reservations are described. Section 5.3.1 of 3GPP TS 38.304 v16.4.0 may be referred.

Cell status and cell reservations are indicated in the MIB or SIB1 message by means of following fields:
cellBarred (IE type: “barred” or “not barred”)

Indicated in MIB message. In case of multiple PLMNs or NPNs indicated in SIB1, this field is common for all PLMNs and NPNs
cellReservedForOperator Use (IE type: “reserved” or “not reserved”)

Indicated in SIB1 message. In case of multiple PLMNs or NPNs indicated in SIB1, this field is specified per PLMN or per SNPN.
cellReservedForOther Use (IE type: “true”)

Indicated in SIB1 message. In case of multiple PLMNs indicated in SIB1, this field is common for all PLMNs.
cellReservedForFutureUse (IE type: “true”)

Indicated in SIB1 message. In case of multiple PLMNs or NPNs indicated in SIB1, this field is common for all PLMNs and NPNs.

IAB-MT ignores the cellBarred, cellReservedForOperator Use, cellReservedForFutureUse and intraFreqReselection (i.e. treats intraFreqReselection as if it was set to allowed). IAB-MT also ignores cellReservedForOtherUse for cell barring determination (i.e. NPN capable IAB-MT considers cellReservedForOtherUse for determination of an NPN-only cell).
iab-Support (IE type: “true”)

Indicated in SIB1 message. In case of multiple PLMNs or NPNs indicated in SIB1, this field is specified per PLMN or per SNPN.

When cell status is indicated as “not barred” and “not reserved” for operator use and not “true” for other use and not “true” for future use,
All UEs shall treat this cell as candidate during the cell selection and cell reselection procedures.

When cell broadcasts any CAG-IDs or NIDs and the cell status is indicated as “not barred” and “not reserved” for operator use and “true” for other use, and not “true” for future use:
All NPN-capable UEs shall treat this cell as candidate during the cell selection and cell reselection procedures, other UEs shall treat this cell as if cell status is “barred”.

When cell status is indicated as “true” for other use, and either cell does not broadcast any CAG-IDs or NIDs or does not broadcast any CAG-IDs and the UE is not operating in SNPN Access Mode,
The UE shall treat this cell as if cell status is “barred”.

When cell status is indicated as “true” for future use,
The UE shall treat this cell as if cell status is “barred”.

When cell status is indicated as “not barred” and “reserved” for operator use for any PLMN/SNPN and not “true” for other use and not “true” for future use,
UEs assigned to Access Identity 11 or 15 operating in their HPLMN/EHPLMN shall treat this cell as candidate during the cell selection and reselection procedures if the field cellReservedForOperator Use for that PLMN set to “reserved”.
UEs assigned to Access Identity 11 or 15 shall treat this cell as candidate during the cell selection and reselection procedures if the field cellReservedForOperator Use for selected/registered SNPN is set to “reserved”.
UEs assigned to an Access Identity 0, 1, 2 and 12 to 14 shall behave as if the cell status is “barred” in case the cell is “reserved for operator use” for the registered PLMN/SNPN or the selected PLMN/SNPN.

Access Identities 11, 15 are only valid for use in the HPLMN/EHPLMN; Access Identities 12, 13, 14 are only valid for use in the home country.

When cell status “barred” is indicated or to be treated as if the cell status is “barred”,
The UE is not permitted to select/reselect this cell, not even for emergency calls.
The UE shall select another cell according to the following rule:
If the cell is to be treated as if the cell status is “barred” due to being unable to acquire the MIB:
the UE may exclude the barred cell as a candidate for cell selection/reselection for up to 300 seconds.
the UE may select another cell on the same frequency if the selection criteria are fulfilled.
else:
If the field intraFreqReselection in MIB message is set to “allowed”, the UE may select another cell on the same frequency if re-selection criteria are fulfilled:
The UE shall exclude the barred cell as a candidate for cell selection/reselection for 300 seconds.
If the field intraFreqReselection in MIB message is set to “not allowed”:
If the cell operates in licensed spectrum, or if this cell belongs to a PLMN which is indicated as being equivalent to the registered PLMN or the selected PLMN of the UE, or if this cell belongs to the registered SNPN or the selected SNPN of the UE:
the UE shall not re-select a cell on the same frequency as the barred cell;
else:
the UE may select to another cell on the same frequency if reselection criteria are fulfilled.
The UE shall exclude the barred cell and, if the cell operates in licensed spectrum or if this cell belongs to a PLMN which is indicated as being equivalent to the registered PLMN, also the cells on the same frequency as a candidate for cell selection/reselection for 300 seconds.

The cell selection of another cell may also include a change of RAT.

Hereinafter, an example of SystemInformationBlockTypel is described.

SystemInformationBlockTypel contains information relevant when evaluating if a UE is allowed to access a cell and defines the scheduling of other system information. SystemInformationBlockType 1-BR uses the same structure as SystemInformationBlockType 1.

Signalling radio bearer: N/A

RLC-SAP: TM

Logical channels: BCCH and BR-BCCH

### Direction: E-UTRAN to UE

Table 6 shows an example of SIB1.

TABLE 6
-- ASN1START
SystemInformationBlockType1-BR-r13 ::= SystemInformationBlockType1

| SystemInformationBlockType1 ::= | SEQUENCE { | | |
|---|---|---|---|
| cellAccessRelatedInfo | SEQUENCE { | | |
| plmn-IdentityList | PLMN-IdentityList, | | |
| trackingAreaCode | TrackingAreaCode, | | |
| cellIdentity | CellIdentity, | | |
| cellBarred | ENUMERATED {barred, notBarred}, | | |
| intraFreqReselection | ENUMERATED {allowed, notAllowed}, | | |
| csg-Indication | BOOLEAN, | | |
| csg-Identity | CSG-Identity | OPTIONAL | -- Need OR |

},

| cellSelectionInfo | SEQUENCE { | | |
|---|---|---|---|
| q-RxLevMin | Q-RxLevMin, | | |
| q-RxLevMinOffset | INTEGER (1..8) | OPTIONAL | -- Need OP |

},

| | | | |
|---|---|---|---|
| p-Max | P-Max | OPTIONAL, | -- |

Need OP

| freqBandIndicator | FreqBandIndicator, | | |
|---|---|---|---|
| schedulingInfoList | SchedulingInfoList, | | |
| tdd-Config | TDD-Config | OPTIONAL, | -- Cond TDD |

| si-WindowLength | ENUMERATED { | |
|---|---|---|
| | ms1, ms2, ms5, ms10, ms15, ms20, | |
| | ms40}, | |
| systemInfoValueTag | INTEGER (0..31), | |
| nonCriticalExtension | SystemInformationBlockType1-v890-IEs | OPTIONAL |

}

In NR, for (new) SMTC and Measurement Gap based requirements in NTN, Propagation delay and/or reception power differences between cells (or between GEO type satellites, between LEO type satellites at the same altitude, between earth fixed cells or between earth moving cells) have been discussed.

Meanwhile, if a UE uses a less number of Rx branches than other UEs around, the base station may use high-powered transmissions to the UE to compensate poor reception conditions. If the UE detects reception power strength becomes stronger, the UE may also set stronger transmitting power because it assumes that a stronger power level is required for communications between the UE and the base station. For example, the UE using the 1Rx branch may use higher power strength to communicate with the base station than that of the UE using the 4Rx branches.

For non-terrestrial networks (NTN), reception power could be different depending on the types of satellites or the types of cells (for example, GEO type, LEO type, between GEO/LEO types, earth fixed cells, earth moving cells). In addition, the power strength to communicate with NTN and TN could be different from each other. Communication power in NTN would require more transmitting power than that in TN. Thus, UEs may use differentiated power strength depending on the types of networks (that is NTN, TN), satellites, or cells.

Strong communication power may increase the probability of interferences with other UEs using the same frequency. Especially, if the number of UEs deployed in the area is many such as Industrial Wireless Sensor Network (IWSN) scenarios. The legacy intra-cell reselection indication specified by a cell, however, does not consider different communication power strength among UEs.

As UE radio capabilities such as the number of antenna branches or differentiated reception power affect communication power between the UE and the base station, it is beneficial to consider UE radio capabilities to decide whether the cell or the cells on the same frequency as a candidate for intra-frequency cell reselection.

If a cell allows intra-frequency cell reselection for all UEs without considering different UE radio capabilities, the UEs using stronger communication power than others will cause interferences, and eventually, all UEs in the area will suffer from interferences.

Therefore, studies for intra-frequency cell reselection considering radio capability in a wireless communication system are required.

Hereinafter, a method for intra-frequency cell reselection considering radio capability in a wireless communication system, according to some embodiments of the present disclosure, will be described with reference to the following drawings.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings. Herein, a wireless device may be referred to as a user equipment (UE).

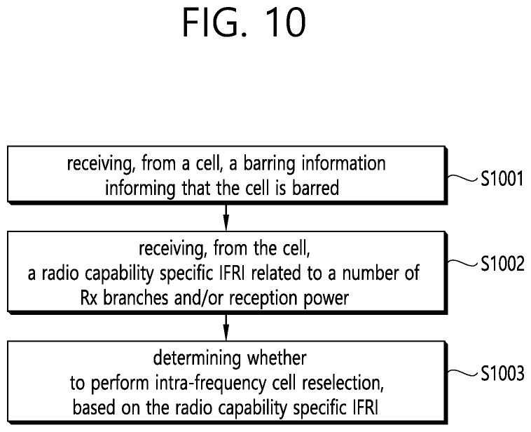

FIG. 10 shows an example of a method for intra-frequency cell reselection considering radio capability in a wireless communication system, according to some embodiments of the present disclosure.

In particular, FIG. 10 shows an example of a method performed by a wireless device. For example, the wireless device may be a UE supporting Reduced Capability (RedCap) (or NR-RedCap).

In step S1001, a wireless device may receive, from a cell, barring information informing that the cell is barred.

For example, the barring information may be included in a Master Information Block (MIB) and/or a System Information Block Type 1 (SIB1).

For example, the MIB and/or the SIB1 may be broadcasted from the cell.

In step S1002, the wireless device may receive, from the cell, a radio capability-specific intra-frequency cell reselection indicator (IFRI) related to a number of Rx branches and/or reception power.

For example, the radio capability-specific IFRI may be included in the MIB and/or the SIB1.

In step S1003, the wireless device may determine whether to perform intra-frequency cell reselection, based on the radio capability-specific IFRI.

For example, the wireless device may perform both intra-frequency cell reselection and inter-frequency cell reselection, based on the determining to perform the intra-frequency cell reselection.

For example, the wireless device may perform only inter-frequency cell reselection without the intra-frequency cell reselection, based on the determining not to perform the intra-frequency cell reselection.

According to some embodiments of the present disclosure, the wireless device may consider cell reselection to other cells on the same frequency as the cell as not allowed for a certain time, based on determining not to perform intra-frequency cell reselection. In this case, the certain time may be informed by the cell.

According to some embodiments of the present disclosure, the radio capability-specific IFRI may inform a specific number of Rx branches for which the intra-frequency cell reselection is allowed. For example, when the wireless device has the specific number of Rx branches, the wireless device may consider that the intra-frequency cell reselection is allowed. When the wireless device does not have the specific number of Rx branches, the wireless device may consider that the intra-frequency cell reselection is not allowed.

According to some embodiments of the present disclosure, the radio capability-specific IFRI may inform a specific number of antenna for which the intra-frequency cell reselection is allowed.

According to some embodiments of the present disclosure, the radio capability-specific IFRI may inform a specific number of Rx branches for which the intra-frequency cell reselection is not allowed. For example, when the wireless device has the specific number of Rx branches, the wireless device may consider that the intra-frequency cell reselection is not allowed. When the wireless device does not have the specific number of Rx branches, the wireless device may consider that the intra-frequency cell reselection is allowed.

According to some embodiments of the present disclosure, the radio capability-specific IFRI informs a minimum number of Rx branches. For example, when a number of Rx branches of the wireless device is greater than or equal to the minimum number of Rx branches, the wireless device may consider that the intra-frequency cell reselection is allowed. When a number of Rx branches of the wireless device is less than the minimum number of Rx branches, the wireless device may consider that the intra-frequency cell reselection is not allowed.

According to some embodiments of the present disclosure, the radio capability-specific IFRI informs a maximum number of Rx branches. For example, when a number of Rx branches of the wireless device is less than or equal to the maximum number of Rx branches, the wireless device may consider that the intra-frequency cell reselection is allowed. When a number of Rx branches of the wireless device is greater than the maximum number of Rx branches, the wireless device may consider that the intra-frequency cell reselection is not allowed.

According to some embodiments of the present disclosure, the radio capability-specific IFRI informs a maximum reception power. For example, when reception power of the wireless device is less than or equal to the maximum reception power, the wireless device may consider that the intra-frequency cell reselection is allowed. When reception power of the wireless device is greater than the maximum reception power, the wireless device may consider that the intra-frequency cell reselection is not allowed.

According to some embodiments of the present disclosure, the radio capability-specific IFRI informs a minimum reception power. For example, when reception power of the wireless device is greater than or equal to the minimum reception power, the wireless device may consider that the intra-frequency cell reselection is allowed. When reception power of the wireless device is less than the minimum reception power, the wireless device may consider that the intra-frequency cell reselection is not allowed.

According to some embodiments of the present disclosure, the wireless device may be in communication with at least one of a user equipment, a network, or an autonomous vehicle other than the wireless device.

Hereinafter, an example of radio capability-specific intra-frequency cell reselection.

According to some embodiments of the present disclosure, in order to implement a radio capability-specific intra-frequency (re)selection procedure, the UE may receive, from the network, differentiated intra-frequency cell reselection information element (IFRI) depending on the radio capabilities of a UE and/or the network, such as a number of antennas or Rx branches used by the UE or reception power. Then, the UE may decide whether it excludes the cells on the same frequency as a candidate for intra-frequency cell reselection or not, based on the radio capability-specific IFRI.

For the convenience of explanation, herein, “legacy IFRI” may be IFRI specified in Release-15/16 and prior versions of 3GPP TS 36.331/38.331 specifications, which is IFRI without differentiation depending on UE radio capabilities such as the number of antenna or reception power strength.

In addition, “radio capabilities specific IFRI” may mean IFRI proposed in the present disclosure. This IFRI (that is, radio capabilities specific IFRI) may be “antenna specific IFRI” or “communication power specific IFRI” depending on the UE's antenna characteristics such as the number of Rx branches or the UE's reception or transmission power strength.

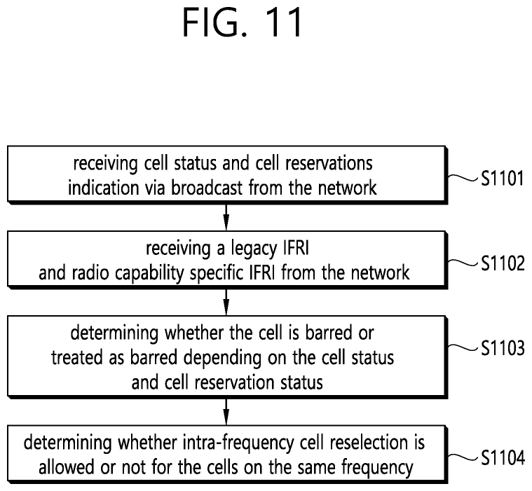

FIG. 11 shows an example of operations for radio capability-specific intra-frequency cell reselection.

In step S1101, the UE may receive cell status and cell reservations indication via broadcast (for example, MIB or SIB1) from the network.

For example, the UE may receive an indication that the cell is “barred” or “not barred” from the network.

For example, the UE may receive an indication that the cell is “reserved for operator use” or “not reserved for operator use” from the network.

For example, the UE may receive an indication that the cell is “reserved for other use” or “not reserved for other use” from the network.

For example, the UE may receive an indication that the cell is “reserved for future use” or “not reserved for future use” from the network.

Depending on the UE capabilities (for example, Non-public network (NPN)-capable UEs), the UE may decide whether the cell is treated as barred or not.

For example, NPN-capable UEs may consider the cell is “not barred” if the cell indicates the cell status is “not barred”, “not reserved for operator use”, “not reserved for future use”, and/or “reserved for other use”, while other UEs may consider the cell is “barred” in this case.

In step S1102, the UE may receive a legacy IFRI and radio capability-specific IFRI from the network.

For example, the UE may receive radio capability-specific IFRI via broadcast (for example, SIB1).

The UE may receive radio capability-specific IFRI depending on the number of Rx branches from the network.

For example, the UE may receive radio capability-specific IFRI for 1Rx=“notAllowed” (for example, intraFreqReselection1rx=“notAllowed”) meaning that if the UE uses 1Rx branches, intra-frequency cell (re)selection is not allowed.

For example, the UE may receive radio capability-specific IFRI for 2Rx=“notAllowed” (for example, intraFreqReselection2rx=“notAllowed”) meaning that if the UE uses 2Rx branches, intra-frequency cell (re)selection is not allowed.

For example, the UE may receive radio capability-specific IFRI for 4Rx=“Allowed” (for example, intraFreqReselection4rx=“Allowed”) meaning that if the UE uses 4Rx branches, intra-frequency cell (re)selection is allowed.

The UE may receive radio capability-specific IFRI depending on reception power from the network.

For example, the UE may receive radio capability-specific IFRI for XdB=“notAllowed” (for example, intraFreqReselectionXdB=“notAllowed”) meaning that if the transmitting or reception power of the UE is less than or equal to XdB, intra-frequency cell (re)selection is not allowed.

For example, the UE may receive radio capability-specific IFRI for XdB=“notAllowed” (for example, intraFreqReselectionXdB=“notAllowed”) meaning that if the transmitting or reception power of the UE is greater than or equal to XdB, intra-frequency cell (re)selection is not allowed.

In step S1103, the UE may determine whether the cell is barred or treated as barred depending on the cell status and cell reservation status.

In step S1104, if the UE determines the cell is barred or treated as barred, the UE may determine whether intra-frequency cell reselection is allowed or not for the cells on the same frequency.

For example, the determination may be based on radio capability-specific IFRI or legacy IFRI. If radio specific or legacy IFRI indicates “not allowed”, the UE may exclude the cell and the cells on the same frequency as a candidate for intra-frequency cell (re)selection for a certain time. If radio specific or legacy IFRI indicates “allowed”, the UE excludes the cell as a candidate for intra-frequency cell (re)selection for a certain time.

If the UE has received radio capability-specific IFRI corresponding to the UE radio capabilities, such as the number of Rx branches and reception power, the UE may apply the radio capability-specific IFRI and ignores legacy IFRI.

For example, if the UE uses 1Rx branches and IFRI for 1Rx and legacy IFRI is broadcast, the UE may apply IFRI for 1Rx. For example, if the UE using the 1Rx branch receives intraFreqReselection1rx=″notAllowed” and intraFreqReselection=“Allowed”, the UE excludes the cell and the cells on the same frequency as a candidate for cell (re)selection for a certain time.

If the UE has not received radio capability-specific IFRI corresponding to the UE radio capabilities, the UE may apply legacy IFRI.

For example, if the UE uses 2Rx branches and only IFRI for 1Rx (not for 2Rx) is broadcast, the UE may apply legacy IFRI.

For example, if the UE uses 1Rx branch and only IFRI for 2Rx (not for 1Rx) is broadcast, the UE may apply legacy IFRI.

For example, if the UE uses 1Rx branch and only legacy IFRI is broadcast, the UE may apply legacy IFRI.

The UE may exclude the cell or the cells on the same frequency as a candidate for cell (re)selection for “a certain time”.

For example, “a certain time” may be 300 seconds.

For example, “a certain time” may be the time indicated by the network.

According to some embodiments of the present disclosure, a UE may receive cell access information via broadcast. The UE may receive radio capabilities specific intra-frequency cell reselection indicator.

For cell reselection, the UE may exclude only the cell as a candidate for a certain time. That is, the cell may be treated as barred and intra-frequency cell reselection corresponding to the UE radio capabilities is allowed.

For cell reselection, the UE may exclude the cell and the cells on the same frequency for cell reselection for a certain time. That is, the cell may be treated as barred and intra-frequency cell reselection corresponding to the UE radio capabilities is not allowed.

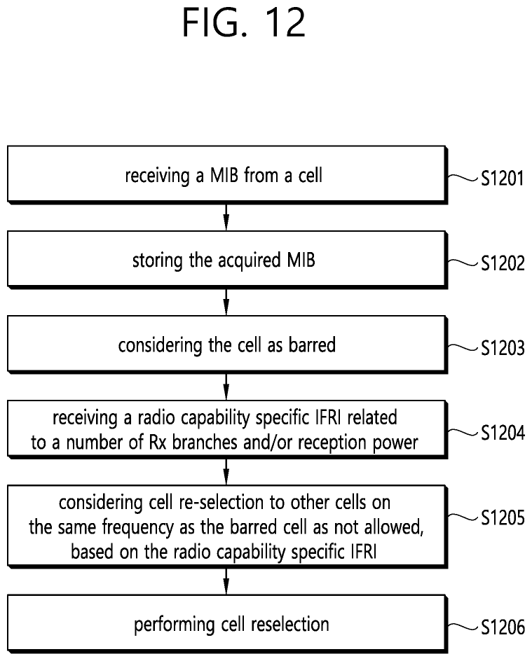

FIG. 12 shows an example of UE operations for radio capability-specific intra-frequency cell reselection.

In step S1201, UE may receive a Master Information Block (MIB) from a cell.

For example, the MIB may be broadcasted by the cell over Broadcast Channel (BCH) and/or Physical Broadcast Channel (PBCH)

In step S1202, upon receiving the MIB, the UE may store the acquired MIB.

In step S1203, the UE may consider the cell as barred.

For example, if the UE is in RRC_IDLE or in RRC_INACTIVE, or if the UE is in RRC_CONNECTED while T311 is running, and if the cellBarred in the acquired MIB is set to barred, the UE may consider the cell as barred.

In step S1204, the UE may receive a radio capability-specific intra-frequency cell reselection indicator (IFRI) related to a number of Rx branches and/or reception power.

For example, the radio capability-specific IFRI may be included in the MIB. For other example, the UE may receive the radio capability-specific IFRI from the cell through another system information block (for example, a SIB1).

In step S1205, the UE may consider cell re-selection to other cells on the same frequency as the barred cell as not allowed, based on the radio capability-specific IFRI.

For example, if the radio capability-specific IFRI is set to notAllowed, the UE may consider cell re-selection to other cells on the same frequency as the barred cell as not allowed.

For example, if the radio capability-specific IFRI is set to notAllowed. and if the cell operates in licensed spectrum or the cell belongs to a PLMN which is indicated as being equivalent to the registered PLMN or the cell belongs to the registered SNPN of the UE, the UE may consider cell re-selection to other cells on the same frequency as the barred cell as not allowed.

According to some embodiments of the present disclosure, the UE may consider cell re-selection to other cells on the same frequency as the barred cell as not allowed, based on a legacy Intra-frequency Reselection Indication (IFRI) (that is, which is not a radio capability-specific IFRI). For example, the UE may determine whether cell re-selection to other cells on the same frequency as the barred cell as not allowed, based on the legacy IFRI, when the radio capability-specific IFRI is not included in the MIB (or when the UE did not receive the radio specific IFRI). For example, the legacy IFRI may be included in the MIB.

For example, if intraFreqReselection (that is, the legacy IFRI) is set to notAllowed. and if the cell operates in licensed spectrum or the cell belongs to a PLMN which is indicated as being equivalent to the registered PLMN or the cell belongs to the registered SNPN of the UE, the UE may consider cell re-selection to other cells on the same frequency as the barred cell as not allowed.

Otherwise, the UE may consider cell re-selection to other cells on the same frequency as the barred cell as allowed.

In step S1206, the UE may perform cell reselection.

For example, the UE may perform both intra-frequency cell reselection and inter-frequency cell reselection. For example, if the radio capability-specific IFRI is not set to notAllowed, the UE may perform both intra-frequency cell reselection and inter-frequency cell reselection, by considering cell re-selection to other cells on the same frequency as the barred cell as allowed. For example, For example, the UE may first perform the intra-frequency cell reselection. If no cell is selected, then the UE may inter-frequency cell reselection. For other example, the UE may first perform the inter-frequency cell reselection. If no cell is selected, the UE may intra-frequency cell reselection. For another example, the UE may perform both intra-frequency cell reselection and inter-frequency cell reselection together.

For other example, the UE may perform only inter-frequency cell reselection. For example, if the radio capability-specific IFRI is set to notAllowed, the UE may perform only the inter-frequency cell reselection, by considering cell re-selection to other cells on the same frequency as the barred cell as not allowed.

According to some embodiments of the present disclosure, the UE may not consider the cell as barred, if the cellBarred in the acquired MIB is not set to barred. In this case, the

UE may apply the received systemFrameNumber, pdcch-ConfigSIB1, subCarrierSpacingCommon, ssb-SubcarrierOffset and dmrs-TypeA-Position.

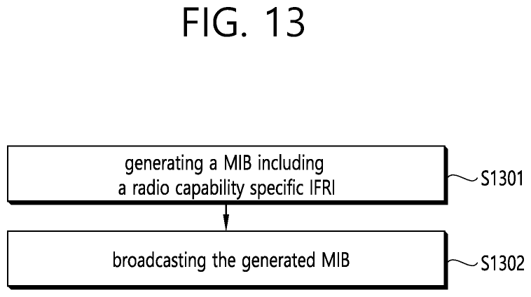

FIG. 13 shows an embodiment of operations of a base station for radio capability-specific intra-frequency cell reselection.

In step S1301, the base station may generate a Master Information Block (MIB) including a radio capability-specific IFRI. For example, the radio capability-specific IFRI may be related to a number of Rx branches and/or reception power.

In step S1302, the base station may broadcast the generated MIB.

Some of the detailed steps shown in the examples of FIGS. 10, 11, 12, and 13 may not be essential steps and may be omitted. In addition to the steps shown in FIGS. 10, 11, 12, and 13, other steps may be added, and the order of the steps may vary. Some of the above steps may have their own technical meaning.

Hereinafter, an apparatus for intra-frequency cell reselection considering radio capability in a wireless communication system, according to some embodiments of the present disclosure, will be described. Herein, the apparatus may be a wireless device (100 or 200) in FIGS. 2, 3, and 5.

For example, a wireless device may perform the methods described above. The detailed description overlapping with the above-described contents could be simplified or omitted.

Referring to FIG. 5, a wireless device 100 may include a processor 102, a memory 104, and a transceiver 106.

According to some embodiments of the present disclosure, the processor 102 may be configured to be coupled operably with the memory 104 and the transceiver 106.

The processor 102 may be configured to control the transceiver 106 to receive, from a cell, barring information informing that the cell is barred. The processor 102 may be configured to control the transceiver 106 to receive, from the cell, a radio capability-specific intra-frequency cell reselection indicator (IFRI) related to a number of Rx branches and/or reception power. The processor 102 may be configured to determine whether to perform intra-frequency cell reselection, based on the radio capability-specific IFRI.

For example, the barring information may be included in a Master Information Block (MIB) and/or a System Information Block Type 1 (SIB1).

For example, the radio capability-specific IFRI may be included in the MIB and/or the SIB1.

For example, the MIB and/or the SIB1 may be broadcasted from the cell.

For example, the processor 102 may be configured to perform both intra-frequency cell reselection and inter-frequency cell reselection, based on the determining to perform the intra-frequency cell reselection.

For example, the processor 102 may be configured to perform only inter-frequency cell reselection without the intra-frequency cell reselection, based on the determining not to perform the intra-frequency cell reselection.

For example, the radio capability-specific IFRI may inform a specific number of Rx branches for which the intra-frequency cell reselection is allowed.

For example, the radio capability-specific IFRI may inform a minimum number of Rx branches. In this case, it may be determined to perform the intra-frequency cell reselection, based on that a number of Rx branches of the wireless device is greater than or equal to the minimum number of Rx branches.

For example, the radio capability-specific IFRI may inform a specific number of antenna for which the intra-frequency cell reselection is allowed.

For example, the radio capability-specific IFRI may inform maximum reception power. In this case, it may be determined to perform the intra-frequency cell reselection, based on that reception power of the wireless device is less than or equal to the maximum reception power.

For example, the processor 102 may be configured to consider cell reselection to other cells on the same frequency as the cell as not allowed for a certain time, based on determining not to perform intra-frequency cell reselection. For example, the certain time may be informed by the cell.

According to some embodiments of the present disclosure, the processor 102 may be configured to be in communication with at least one of a user equipment, a network, or an autonomous vehicle other than the wireless device.

Hereinafter, a processor for a wireless device for intra-frequency cell reselection considering radio capability in a wireless communication system, according to some embodiments of the present disclosure, will be described.

The processor may be configured to control the wireless device to receive, from a cell, barring information informing that the cell is barred. The processor may be configured to control the wireless device to receive, from the cell, a radio capability-specific intra-frequency cell reselection indicator (IFRI) related to a number of Rx branches and/or reception power.

The processor may be configured to control the wireless device to determine whether to perform intra-frequency cell reselection, based on the radio capability-specific IFRI.

For example, the barring information may be included in a Master Information Block (MIB) and/or a System Information Block Type 1 (SIB1).

For example, the radio capability-specific IFRI may be included in the MIB and/or the SIB1.

For example, the MIB and/or the SIB1 may be broadcasted from the cell.

For example, the processor may be configured to control the wireless device to perform both intra-frequency cell reselection and inter-frequency cell reselection, based on the determining to perform the intra-frequency cell reselection.

For example, the processor may be configured to control the wireless device to perform only inter-frequency cell reselection without the intra-frequency cell reselection, based on the determining not to perform the intra-frequency cell reselection.

For example, the radio capability-specific IFRI may inform a specific number of Rx branches for which the intra-frequency cell reselection is allowed.

For example, the radio capability-specific IFRI may inform a minimum number of Rx branches. In this case, it may be determined to perform the intra-frequency cell reselection, based on that a number of Rx branches of the wireless device is greater than or equal to the minimum number of Rx branches.

For example, the radio capability-specific IFRI may inform a specific number of antenna for which the intra-frequency cell reselection is allowed.

For example, the radio capability-specific IFRI may inform maximum reception power. In this case, it may be determined to perform the intra-frequency cell reselection, based on that reception power of the wireless device is less than or equal to the maximum reception power.

For example, the processor may be configured to control the wireless device to consider cell reselection to other cells on the same frequency as the cell as not allowed for a certain time, based on determining not to perform intra-frequency cell reselection. For example, the certain time may be informed by the cell.

According to some embodiments of the present disclosure, the processor may be configured to control the wireless device to be in communication with at least one of a user equipment, a network, or an autonomous vehicle other than the wireless device.

Hereinafter, a non-transitory computer-readable medium has stored thereon a plurality of instructions for intra-frequency cell reselection considering radio capability in a wireless communication system, according to some embodiments of the present disclosure, will be described.

According to some embodiment of the present disclosure, the technical features of the present disclosure could be embodied directly in hardware, in a software executed by a processor, or in a combination of the two. For example, a method performed by a wireless device in a wireless communication may be implemented in hardware, software, firmware, or any combination thereof. For example, a software may reside in RAM memory, flash memory, ROM memory, EPROM memory, EEPROM memory, registers, hard disk, a removable disk, a CD-ROM, or any other storage medium.

Some example of storage medium is coupled to the processor such that the processor can read information from the storage medium. In the alternative, the storage medium may be integral to the processor. The processor and the storage medium may reside in an ASIC. For another example, the processor and the storage medium may reside as discrete components.

The computer-readable medium may include a tangible and non-transitory computer-readable storage medium.

For example, non-transitory computer-readable media may include random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some embodiment of the present disclosure, a non-transitory computer-readable medium has stored thereon a plurality of instructions. The stored a plurality of instructions may be executed by a processor of a wireless device.

The stored a plurality of instructions may cause the wireless device to receive, from a cell, barring information informing that the cell is barred. The stored a plurality of instructions may cause the wireless device to receive, from the cell, a radio capability-specific intra-frequency cell reselection indicator (IFRI) related to a number of Rx branches and/or reception power. The stored a plurality of instructions may cause the wireless device to determine whether to perform intra-frequency cell reselection, based on the radio capability-specific IFRI.

For example, the barring information may be included in a Master Information Block (MIB) and/or a System Information Block Type 1 (SIB1).

For example, the radio capability-specific IFRI may be included in the MIB and/or the SIB1.

For example, the MIB and/or the SIB1 may be broadcasted from the cell.

For example, the stored a plurality of instructions may cause the wireless device to perform both intra-frequency cell reselection and inter-frequency cell reselection, based on the determining to perform the intra-frequency cell reselection.

For example, the stored a plurality of instructions may cause the wireless device to perform only inter-frequency cell reselection without the intra-frequency cell reselection, based on the determining not to perform the intra-frequency cell reselection.

For example, the radio capability-specific IFRI may inform a specific number of Rx branches for which the intra-frequency cell reselection is allowed.

For example, the radio capability-specific IFRI may inform a minimum number of Rx branches. In this case, it may be determined to perform the intra-frequency cell reselection, based on that a number of Rx branches of the wireless device is greater than or equal to the minimum number of Rx branches.

For example, the radio capability-specific IFRI may inform a specific number of antenna for which the intra-frequency cell reselection is allowed.

For example, the radio capability-specific IFRI may inform maximum reception power. In this case, it may be determined to perform the intra-frequency cell reselection, based on that reception power of the wireless device is less than or equal to the maximum reception power.

For example, the stored a plurality of instructions may cause the wireless device to consider cell reselection to other cells on the same frequency as the cell as not allowed for a certain time, based on determining not to perform intra-frequency cell reselection. For example, the certain time may be informed by the cell.

According to some embodiments of the present disclosure, the stored a plurality of instructions may cause the wireless device to be in communication with at least one of a user equipment, a network, or an autonomous vehicle other than the wireless device.

Hereinafter, a base station (BS) for radio capability-specific intra-frequency cell reselection, according to some embodiments of the present disclosure, will be described.

The BS may include a transceiver, a memory, and a processor operatively coupled to the transceiver and the memory.

The processor may be configured to generate a Master Information Block (MIB) including a radio capability-specific IFRI. For example, the radio capability-specific IFRI may be related to a number of Rx branches and/or reception power.

The processor may be configured to control the transceiver to broadcast the generated MIB.

The present disclosure can have various advantageous effects.

According to some embodiments of the present disclosure, a wireless device could perform intra-frequency cell reselection efficiently by considering radio capability.

For example, the UE could determine candidate cells for intra-frequency cell (re)selection based on the network indicator considering radio capabilities such as the number of antennas and reception power of UEs. Therefore, it is possible for the base station to efficiently control the network interferences.

In other words, by applying radio capability-specific IFRI, it is possible to determine whether each UE performs intra-frequency cell reselection based on the UE's capability. In addition, by considering communication power, it is possible to reduce communication failure due to interference.

For example, efficient network management could be possible. Since more sophisticated interference control is possible by introducing an intra-frequency cell reselection tolerance factor in consideration of the communication power of the UE. In terms of the UE, it is possible to reduce communication failure due to interference.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method performed by a wireless device in a wireless communication system, comprising:
receiving, from a cell, barring information informing that the cell is barred;
receiving, from the cell, a radio capability-specific intra-frequency cell reselection indicator (IFRI) related to a number of Rx branches and/or reception power; and
determining whether to perform intra-frequency cell reselection, based on the radio capability-specific IFRI.

2. The method of claim 1,
wherein the barring information is included in a Master Information Block (MIB) and/or a System Information Block Type 1 (SIB1).

3. The method of claim 2,
wherein the radio capability-specific IFRI is included in the MIB and/or the SIB1.

4. The method of claim 2,
wherein the MIB and/or the SIB1 is broadcasted from the cell.

5. The method of claim 1, wherein the method further comprises,
performing both intra-frequency cell reselection and inter-frequency cell reselection, based on the determining to perform the intra-frequency cell reselection.

6. The method of claim 1, wherein the method further comprises,
performing only inter-frequency cell reselection without the intra-frequency cell reselection, based on the determining not to perform the intra-frequency cell reselection.

7. The method of claim 1,
wherein the radio capability-specific IFRI informs a specific number of Rx branches for which the intra-frequency cell reselection is allowed.

8. The method of claim 1,
wherein the radio capability-specific IFRI informs a minimum number of Rx branches.

9. The method of claim 8,
wherein it is determined to perform the intra-frequency cell reselection, based on that a number of Rx branches of the wireless device is greater than or equal to the minimum number of Rx branches.

10. The method of claim 1,
wherein the radio capability-specific IFRI informs a specific number of antenna for which the intra-frequency cell reselection is allowed.

11. The method of claim 1,
wherein the radio capability-specific IFRI informs maximum reception power.

12. The method of claim 11,
wherein it is determined to perform the intra-frequency cell reselection, based on that reception power of the wireless device is less than or equal to the maximum reception power.

13. The method of claim 1, wherein the method further comprises,
considering cell reselection to other cells on the same frequency as the cell as not allowed for a certain time, based on determining not to perform intra-frequency cell reselection.

14. The method of claim 13,
wherein the certain time is informed by the cell.

15. The method of claim 1, wherein the wireless device is in communication with at least one of a user equipment, a network, or an autonomous vehicle other than the wireless device.

16. A wireless device in a wireless communication system comprising:
a transceiver;
a memory; and
at least one processor operatively coupled to the transceiver and the memory, and configured to:
control the transceiver to receive, from a cell, barring information informing that the cell is barred;
control the transceiver to receive, from the cell, a radio capability-specific intra-frequency cell reselection indicator (IFRI) related to a number of Rx branches and/or reception power; and
determine whether to perform intra-frequency cell reselection, based on the radio capability-specific IFRI.

17. The wireless device of claim 16,
wherein the barring information is included in a Master Information Block (MIB) and/or a System Information Block Type 1 (SIB1).

18. The wireless device of claim 17,
wherein the radio capability-specific IFRI is included in the MIB and/or the SIB1.

19. The wireless device of claim 17,
wherein the MIB and/or the SIB1 is broadcasted from the cell.

20-33. (canceled)

34. A base station in a wireless communication system comprising:
a transceiver;
a memory; and
a processor operatively coupled to the transceiver and the memory, and configured to:
generate a radio capability-specific intra-frequency cell reselection indicator (IFRI) related to a number of Rx branches and/or reception power; and
control the transceiver to transmit, to a wireless device, the radio capability-specific IFRI.
